(19) United States
(12) Patent Application Publication
(10) Pub. No.: US 2024/0017445 A1
(43) Pub. Date: Jan. 18, 2024

(54) AN EXTRUSION PROCESS FOR PREPARING A LOW MOLECULAR WEIGHT POLYTETRAFLUOROETHYLENE MICROPOWDER

(71) Applicant: Gujarat Fluorochemicals Limited, Noida (IN)

(72) Inventors: Rajeev CHAUHAN, Gujarat (IN); Deepak KAPOOR, Hamburg (DE); Sanjay BHAN, Gujarat (IN); Navin SONI, Gujarat (IN); Amol PAWAR, Gujarat (IN)

(21) Appl. No.: 17/642,139

(22) PCT Filed: Sep. 19, 2020
(86) PCT No.: PCT/IB2020/058754

§ 371 Date: Mar. 10, 2022

(30) Foreign Application Priority Data
Sep. 19, 2019 (IN) 201911037711

(51) Int. Cl. B29B 9/12; B29B 9/16; B29B 9/06

(52) U.S. Cl. CPC B29B 9/12; B29B 9/16; B29B 9/06; B29B 2009/125

(57) ABSTRACT

The present invention relates to an extrusion process for preparing a low molecular weight PTFE micropowder, comprising the steps of: introducing a PTFE composition into a extruder; applying heat treatment to the extruder; extruding the PTFE composition in an extruder to reduce molecular weight through heat and shear force; cooling and pelletizing in a pelletizer to form granules of PTFE; and reducing the particle size of PTFE granules by milling method to form low molecular weight PTFE micropowder. The present invention also relates to an extrusion process for degradation of high molecular weight PTFE to produce low molecular weight Polytetrafluoroethylene micropowder.

### FIELD OF THE INVENTION

The present invention pertains to a process for preparing micropowder of polymeric material. More particularly the invention relates to a process for preparing low molecular Polytetrafluoroethylene (PTFE) micropowder. More particularly, the present invention relates to polymer degradation by an extrusion process for preparing low molecular weight Polytetrafluoroethylene (PTFE) micropowder.

### BACKGROUND OF THE INVENTION

PTFE micropowders are low molecular weight PTFE, mainly used as an additive in polymers, coatings, paints, rubbers, cosmetics, waxes, inks, adhesives, greases and lubricants.

PTFE Micropowders exhibit impressive array of following properties that make them the material of choice for various demanding applications:
1. Low coefficient of friction
2. Improved wear characteristics in engineering polymers
3. Increased rub resistance in inks and coatings
4. Corrosion resistance
5. Excellent chemical and temperature resistance
6. Improvement in non-stick and release properties
7. Anti-drip

The excellent properties of PTFE notwithstanding, high molecular weight PTFE is rarely used as a modifier of other materials by dispersion or blend. The reason behind these powders are not suitable for dispersion or blend is that the powders are fibrillated due to shear generated during dispersing or blending. Consequently, viscosity of the mixture increases significantly and no uniform mixing of the composition or blend is possible. Accordingly, for dispersing or blending with paints, printing inks, coatings and industrial finishes, oil and grease compositions, the fine particles or powder of low molecular weight PTFE are suitable. Hence; the demand for low molecular weight PTFE is ever increasing.

In prior arts, low molecular weight PTFE powders have been produced typically from high molecular weight PTFE powders by degradation methods like irradiation with high energy electrons from either a gamma source or an electron beam, or high temperature thermal treatment Low molecular weight PTFE micropowders are also produced by direct polymerization technology.

In prior arts, low molecular weight PTFE powders were produced using following three processes:
a. Irradiation process using e-beam or gamma radiation to degrade high molecular weight PTFE to low molecular weight PTFE
b. Directly polymerized to produce low molecular weight PTFE
c. Thermal treatment to degrade high molecular weight PTFE to low molecular weight PTFE

In prior art, U.S. Pat. No. 9266984 titled “Polytetrafluoroethylene resins that can be processed by shaping, shaped products thereof, and processes for producing the resins and shaped products” a process for producing a PTFE resin wherein the PTFE is irradiated was disclosed.

U.S. Pat. No. 7176265B patent titled “Directly polymerized low molecular weight granular polytetrafluoroethylene” discloses direct polymerized low molecular weight PTFE. A process for producing low molecular weight, granular polytetrafluoroethylene or modified polytetrafluoroethylene by suspension polymerization of pressurized tetrafluoroethylene in an agitated reaction vessel. The polymerization is conducted in aqueous medium in the presence of a free radical initiator, and a telogen. The reaction vessel is agitated during polymerization sufficiently to coagulate the polytetrafluoroethylene or modified polytetrafluoroethylene. Low molecular weight granular polytetrafluoroethylene or modified polytetrafluoroethylene having a melt viscosity of less than about 1×10⁶ Pa·S powder is isolated directly from the reaction vessel. The low molecular weight polytetrafluoroethylene or modified polytetrafluoroethylene powder in this patent has a melt viscosity of less than about 1×10⁶ Pa·S, a specific surface area of less than about 8 m²/g, an extractable fluoride level of about 3 ppm or less by weight, and a narrow molecular weight distribution as indicated by a polydispersity index of about 5 or less. The particles of low molecular powder have a weight average particle size of about 2 to about 40 micrometers and the powder is substantially free of particles having a particle size of less than about 1 micrometer. The low molecular weight material so produced suitable for use as additives to other materials such as inks, coatings, greases, lubricants, and plastics.

Irradiation (a) and thermal treatments (c) used for producing low molecular weight PTFE were generating various undesired fluorine containing Per and polyfluoroalkyl substances (PFAS), mainly PFOA that is restricted for use by many regulatory authorities world over. These processes were generally carried out in open conditions (presence of air) that results in polluting environment and causes occupational hazards to workers. Material produced with directly polymerized process (b) was found suitable for use in limited application of PTFE micropowder.

Therefore, there was a strong need for a process for producing low molecular weight PTFE micropowder in controlled environment using a cleaner process and resulting in wide range of products to cater to most of the micropowder application.

The present invention fulfills these needs, and overcomes the drawbacks of the prior art.

OBJECTIVES OF THE INVENTION

The main objective of this invention is to provide a polymer degradation method by extrusion process for the preparation of low molecular weight Polytetrafluoroethylene (PTFE) micropowder that overcomes the aforestated problems.

Another objective of this invention is to provide a clean and safe polymer degradation method using an extrusion process to produce low molecular weight Polytetrafluoroethylene (PTFE) micropowder.

Yet another objective of this invention is to provide a process to produce low molecular weight PTFE micropowder using recycled PTFE waste.

### SUMMARY OF THE INVENTION

The present invention relates to low molecular weight PTFE micropowder and an extrusion process for preparing the same.

In accordance with an aspect of the invention, there is provided an extrusion process for preparing a low molecular weight PTFE micropowder, comprising the steps of:
a. Introducing a PTFE feed material
b. Applying heat and shear force during the extrusion process;
c. Extruding the PTFE feed inside extruder to get low molecular weight PTFE with different melt viscosities
d. Cooling and pelletizing in a pelletizer to form granules of PTFE; and
e. Reducing the particle size of PTFE micropowder granules by milling method to form powder

High molecular weight PTFE feed material may comprise of recycled, sintered, virgin, modified, suspension, emulsion form of PTFE or in a combination of such types. PTFE feed may be in any form -pellet or powder which may require pre-pressing or pre-sintering to make ease of feeding into the extruder.

The extruder design, the screw speed and the temperature profile together defined process conditions to achieve various target melt viscosities of the low molecular PTFE micro powder.

Depending upon final melt viscosity of low molecular weight PTFE micro powder, US FDA status of the product for use in various applications may be achieved.

The low molecular PTFE granules coming from pelletizer may require an additional heating steps to remove any volatiles/ impurity from the product

In accordance with an aspect of the invention, a low molecular weight PTFE powder having melt viscosity of less than equal to 3,00,000 has been disclosed.

In an embodiment, the low molecular weight PTFE micropowder may have an average particle size i.e. (D50) less than equal to 1000 μm.

In an embodiment, The low molecular weight PTFE micropowder may have specific surface area (SSA) which may be less than 8 m²/g.

In accordance with another aspect of the invention, a low molecular weight PTFE micro powder may have the moisture content may be less than 0.1% and the purity may be greater than equal to 99.9%.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting its scope. The invention will be described and explained with additional specificity and detail with the accompanying drawings.

### BRIEF DESCRIPTION OF THE ACCOMPANYING DRAWINGS

The above and other features, aspects, and advantages of the subject matter will be better understood with regard to the following description and accompanying drawings.

FIG. 1. Flowchart for the process for preparing a low molecular weight Polytetrafluoroethylene micropowder.

### DETAILED DESCRIPTION OF THE INVENTION

For the purpose of promoting and understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. Discussed below are some representative embodiments of the present invention. The invention in its broader aspects is not limited to the specific details and representative methods. Illustrative examples are described in this section in connection with the embodiments and methods provided.

It is to be noted that, as used in the specification, the singular forms “a,” “an,” and “the” include plural referents unless the context clearly dictates otherwise. Thus, for example, reference to a composition containing “a compound” includes a mixture of two or more compounds. It should also be noted that the term “or” is generally employed in its sense including “and/or” unless the content clearly dictates otherwise.

The expression of various quantities in terms of “%” or “% w/w” means the percentage by weight of the total solution or composition unless otherwise specified. All cited references are incorporated herein by reference in their entireties. Citation of any reference is not an admission regarding any determination as to its availability as prior art to the claimed invention.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment

The terms “comprises”, “comprising”, or any other variations thereof, are intended to cover a non-exclusive inclusion, such that a process or method that comprises a list of steps does not include only those steps but may include other steps not expressly listed or inherent to such process or method.

Unless otherwise defined, all technical and scientific terms used herein have the same meaning as commonly understood by one of ordinary skill in the art to which this invention belongs. The system, methods, and examples provided herein are illustrative only and not intended to be limiting.

The present invention pertains to an extrusion process for preparing low molecular weight Polytetrafluoroethylene micropowder from high molecular weight PTFE composition. The Polytetrafluoroethylene compoune is hereby defined as “PTFE”.

Preferably, the PTFE feed may comprises of materials selected from any form-powder or pellet, sintered or virgin or recycled, homopolymer or modified, suspension or emulsion or combination thereof.

Embodiments of the present invention will be described below in detail with reference to the accompanying drawing.

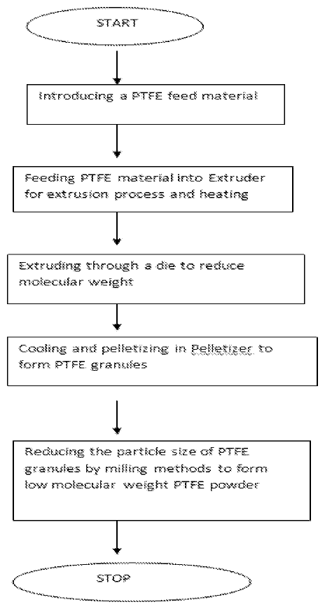

Accordingly, FIG. 1 illustrates process for producing low molecular weight polytetrafluoroethylene micropowder from high molecular weight PTFE composition.

In accordance with an aspect of the invention, there is provided an extrusion process for preparing a low molecular weight PTFE micropowder, comprising the steps of:
a) Introducing a PTFE feed material;
b) Applying heat and shear force during the extrusion process;
c) Extruding the PTFE feed inside extruder to get low molecular weight PTFE with different melt viscosities;
d) Cooling and pelletizing in a pelletizer to form granules of PTFE; and
e) Reducing the particle size of PTFE micropowder granules by milling method to form powder

In an embodiment, PTFE feed material may be in any form -powder or pellets, recycled, sintered or virgin, homopolymer or modified, suspension or emulsion or their combination. The PTFE feed is fed into an extruder. The PTFE feed material may require pre-pressing or pre-sintering to make it easy for feeding into the extruder.

In an embodiment, thermal and shear force are used during the extrusion process. The extrusion should be preferably done at a temperature less than or equal to 550° C.;

In an embodiment, different combinations of extruder geometry may be provided including screw designs (single screw or double screw, co-rotating or counter rotating), temperature conditions and screw Revolutions per minute (RPM), to get the PTFE product with varying melt viscosities and other properties.

In an embodiment, the extruder may be single screw or double screw, co-rotating or counter rotating or other types of extruders. The extruder design, the screw speed and the temperature of heating elements together defined as a process condition are required to achieve target melt viscosity of the low molecular PTFE micro powder. Depending upon final melt viscosity of low molecular weight PTFE micro powder and US FDA, the status of product for use in various applications may be achieved.

The PTFE composition may be introduced into the extruder through a hopper. The extruder consists of two intermeshing screws mounted on shafts in a closed barrel with a heating & cooling system. The screw is composed of three main sections; the feed section, transition section and metering section. The feed section is responsible for conveying the PTFE feed composition to the transition section. The transition section is that part of the screw where melting of the PTFE composition takes place. The metering section delivers the melt toward the discharge end of the extruder. Vacuum may also applied in extruder for devolatization.

Inside the extruder, the extruder temperature may be kept preferably in the range of 200 to 550° C. by electrical heaters .

In an embodiment the rotating screw(s) and the extruder temperature may assist in melting the polymer, and preparing a homogenous melt of the PTFE composition. The decrease in the molecular weight of PTFE may be brought about by shear, temperature and torque inside the extruder.

Finally, the molten PTFE composition is forced through a shaped die by means of pressure. Generally, the die may be attached to the extruder through an adaptor. Preferably, the molten PTFE may be extruded out of the die in the form of strands.

Following the extrusion through extruder, the extruded strands of molten PTFE may be cooled and chopped to form granules in a pelletizer. The cooling and pelletizing may be done in a pelletizer to form granules of PTFE according to the embodiment

In an embodiment, the low molecular PTFE granules coming from pelletizer may require an additional heating step to remove any volatiles/impurity from the product

Following pelletizing, the granules may be further subjected to milling method. The milling of PTFE granules may be done in order to reducing the particle size of PTFE micropowder granules to form powder of various particle size distribution (D50 less than 1000 μm). The milling method may be used in order to produce desired particles size low molecular weight PTFE micropowder.

In an embodiment, the milling method may be mechanical milling and/or air jet milling or other methods thereof.

Melt Viscosity

In accordance with an aspect of the invention, a low molecular weight PTFE powder having melt viscosity of less than or equal to 3,00,000 Poise has been disclosed.

The above melt viscosity may be measured according to ASTM D 1238 using a flow tester (make: Dynisco), die diameter of 2.095 and the value may be measured by preheating 5 g of test sample for 5 min at 380° C. and measuring the same with a load of 2.16 kg while maintaining that temperature.

Particle Size

In an embodiment, the low molecular weight PTFE micropowder may have average particle size [D50] less than equal to 1000 μm.
D50 analysis: Particle size analysis may be done by Particle size analyzer (make:Sympatec Helos KR) with laser diffraction method (pressure of 0.5 bar and Copt:2-15%) as per ASTM D4894

Specific Surface Area

In an embodiment, the low molecular weight PTFE micropowder may have specific surface area (SSA) may be less than 8 m²/g.

The specific surface area may be measured by BET using a surface analyzer (make: Smart Instrument) with a mixed gas of 30% nitrogen and 70% helium as the carrier gas and liquid nitrogen as a coolant.

Purity

In an embodiment, the purity of low molecular weight PTFE may be greater than or equal to 99.9%.

Extruder Temperature

In an embodiment, the extruder temperature may be maintained between 200-550 degree C.

Melting Point

In an embodiment, the melting point of low molecular weight PTFE particles may range from 315 degree C. to 335 degree C.

The temperature inside extruder may be measured by Temperature Controllers and melting point of low molecular weight PTFE particles may be measured by using ASTM D 4591 by using differential scanning calorimeter. Here approximately 3 mg of the low-molecular weight PTFE powder may be placed in a crimped aluminum pan and the temperature may be raised 10° C./min in the temperature range of 240° C. to 380° C. with Nitrogen flow rate of 50 mL/min. The melting point is defined as the maxima of the endothermal peak in the above defined range.

The present invention is more particularly described in the following examples that are intended as illustration only, since numerous modifications and variations within the scope of the present invention will be apparent to those of skill in the art Unless otherwise noted, all parts, percentages, and ratios reported in the following examples are on a weight basis, and all reagents used in the examples were obtained or are available from the chemical suppliers.

The following examples illustrates the basic methodology and versatility of the present invention.

### EXAMPLES

Following batches of low molecular weight PTFE micropowder are prepared according to the present invention: Examples 1, 2 and 3. Their properties are compared with that of commercially available products.

TABLE 1

| | Evaluation | | | | |
|---|---|---|---|---|---|
| Property | procedure | Units | Example 1 | Example 2 | Example 3 |
| PTFE purity | ASTM E2550 | % | 99.93 | 99.91 | 99.92 |
| Average particle | Sieve method | μm | 6000.0 | 6200.0 | 6350.0 |
| size of sintered | | | | | |
| PTFE after crushing | | | | | |
| Extruder Barrel zone | | ° C. | 420.0 | 400.0 | 370.0 |
| temperatures (B1-B2) | | | | | |
| Extruder Barrel zone | | ° C. | 410.0 | 395.0 | 360.0 |
| temperatures (B3-B8) | | | | | |
| Extruder Barrel zone | | ° C. | 420.0 | 400.0 | 370.0 |
| temperatures (B9-B10) | | | | | |
| Extruder screw RPM | | | 330.0 | 310.0 | 290.0 |

Properties

| | | | White free | White free | White free |
|---|---|---|---|---|---|
| | | | flowing | flowing | flowing |
| Appearance | Measurement | Unit | powder | powder | powder |
| Mean Particle | ASTM D4894 | μm | 8 | 30 | 20 |
| Size | | | | | |
| Specific | Nitrogen | m²/g | 2.81 | 2.9 | 2.97 |
| Surface area | Adsorption | | | | |
| Melting point | ASTM D4894 | ° C. | 323 | 326 | 327 |
| | | (° F.) | | | |
| Melt | — | Poise | 1000 | 11000 | 45000 |
| Viscosity(@380° C.) | | | | | |
| FDA | — | | No | Yes | Yes |
| compliance | | | | | |

The invention may be embodied in other specific forms without departing from the spirit or essential characteristics thereof. The present embodiments are therefore to be considered in all respects as illustrative and not restrictive.

The advantages of the present invention are as following:
The main advantage of this invention is to provide a clean and safe polymer degradation method using an extrusion process to produce low molecular weight Polytetrafluoroethylene (PTFE) micropowder.
Yet another advantage of this invention is to provide a process to produce low molecular weight PTFE micropowder using recycled PTFE waste.
Yet another advantage of this invention is to produce low molecular weight with US FDA status for use in various applications.

The drawings and the forgoing description give examples of embodiments. Those skilled in the art will appreciate that one or more of the described elements may well be combined into a single functional element Alternatively, certain elements may be split into multiple functional elements. Elements from one embodiment may be added to another embodiment. For example, order of process described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

We claim:

1. An extrusion process for preparing a low molecular weight PTFE micropowder, comprising the steps of:
a. introducing a PTFE feed material;
b. applying heat and shear force during the extrusion process;
c. extruding the PTFE feed to degrade the polymer by use of heat and shear force to get low molecular weight PTFE with different melt viscosities ;
d. cooling and pelletizing in a pelletizer to form granules of PTFE; and
e. reducing the particle size of PTFE micropowder granules by milling method to produce low molecular weight PTFE micropowder.

2. An extrusion process as claimed in claim 1 wherein low molecular weight PTFE micropowder is made by degradation of high molecular PTFE.

3. The extrusion process as claimed in claim 1, wherein the feed material may be in any form—powder or pellets, sintered or virgin or recycled, homopolymer or modified, suspension or emulsion or their combinations thereof, which is being fed into an extruder.

4. The extrusion process as claimed in claim 1, wherein the extrusion is done at a temperature less than or equal to 550° C.; the extruder temperature of various zones inside the extruder is preferably kept between 200-550 degree C.

5. The extrusion process as claimed in claim 1, wherein the milling method comprises of mechanical milling method or air jet milling method or other milling methods.

6. A low molecular Polytetrafluoroethylene micropowder made by the process as claimed in claim 1, wherein the melt viscosity is less than equal to 300000 poise at 380 degree Celsius.

7. The low molecular Polytetrafluoroethylene micropowder as claimed in claim 6, wherein the average particle size [D50] is less than 1000 μm.

8. The low molecular Polytetrafluoroethylene micropowder as claimed in claim 6, wherein melting point is ranging from 315 to 335° C.

9. The low molecular Polytetrafluoroethylene micropowder as claimed in claim 6, wherein Specific Surface area is less than equal to 8m²/g.

10. The low molecular Polytetrafluoroethylene micropowder as claimed in claim 6, wherein moisture content is less than 0.1% and purity is greater than or equal to 99.9% on w/w basis.
